(19) United States
(12) Patent Application Publication
(10) Pub. No.: US 2014/0030371 A1
(43) Pub. Date: Jan. 30, 2014

(54) APPARATUS INCLUDING PRESSURE-CONTROL ASSEMBLY FOR ADJUSTMENT OF FLUID PRESSURE BETWEEN FLUID-BOTTLE ASSEMBLY AND HYDRAULIC-ACCUMULATOR ASSEMBLY ASSOCIATED WITH MOLDING SYSTEM

(71) Applicants: Gregory Allan Schultz, Bolton, CA (US); Trevor Paul Van Eerde, Innisfil, CA (US)

(72) Inventors: Gregory Allan Schultz, Bolton, CA (US); Trevor Paul Van Eerde, Innisfil, CA (US)

(73) Assignee: Husky Injection Molding Systems LTD., Bolton, CA (US)

(21) Appl. No.: 14/007,131

(22) PCT Filed: Mar. 7, 2012
(86) PCT No.: PCT/CA12/50134

§ 371 Date: Sep. 24, 2013

Related U.S. Application Data
(60) Provisional application No. 61/474,385, filed on Apr. 12, 2011.

(51) Int. Cl. B29C 31/00

(52) U.S. Cl. CPC B29C 31/00
USPC 425/149

(57) ABSTRACT

An apparatus (100), comprising: a pressure-control assembly (104) having: a first interface unit (105) being configured to interface, in use, with a fluid-bottle assembly (102); and a second interface unit (107) being configured to interface, in use, with a hydraulic-accumulator assembly (200), the hydraulic-accumulator assembly (200) being associated with a molding system (202), the hydraulic-accumulator assembly (200) being configured to accumulate, under an hydraulic pressure, an hydraulic fluid, the hydraulic fluid being associated with an hydraulic circuit (204); the pressure-control assembly (104) being configured to: communicate, in use, a fluid pressure between the fluid-bottle assembly (102) and with the hydraulic-accumulator assembly (200); and controllably adjust, in use, the fluid pressure between the fluid-bottle assembly (102) and the hydraulic-accumulator assembly (200), the fluid pressure that is adjusted by the pressure-control assembly (104) varies, in use, the hydraulic pressure associated with the hydraulic-accumulator assembly (200).

### TECHNICAL FIELD

An aspect generally relates to (but is not limited to) a pressure-control assembly and a molding system having a pressure-control assembly.

### SUMMARY

The inventors have researched a problem associated with known molding systems. The problem is related to energy efficiency when producing molded parts. The solution helps to improve the energy efficiency of a molding system (molding machine) during a molding cycle. After much study, the inventors believe they have arrived at an understanding of the problem and its solution, which are stated below, and the inventors believe this understanding is not known to the public.

Known accumulator based molding systems use a single pressure setting for accumulator pre-charge or alternatively may use a manually adjusted pressure setting for accumulator pre-charge. A single setting is based on a worst case scenario and therefore may not be energy efficient for less aggressive applications of the molding system (that is, applications for making or molding other molded parts). Tunable pressure settings may optimize the molding system for energy usage and may reduce energy losses.

To resolve the above problem (at least in part), according to one aspect, there is provided an apparatus (100), comprising: a pressure-control assembly (104) having: a first interface unit (105) being configured to interface, in use, with a fluid-bottle assembly (102); and a second interface unit (107) being configured to interface, in use, with a hydraulic-accumulator assembly (200), the hydraulic-accumulator assembly (200) being associated with a molding system (202), the hydraulic-accumulator assembly (200) being configured to accumulate, under an hydraulic pressure, an hydraulic fluid, the hydraulic fluid being associated with an hydraulic circuit (204); the pressure-control assembly (104) being configured to: communicate, in use, a fluid pressure between the fluid-bottle assembly (102) and with the hydraulic-accumulator assembly (200); and controllably adjust, in use, the fluid pressure between the fluid-bottle assembly (102) and the hydraulic-accumulator assembly (200), the fluid pressure that is adjusted by the pressure-control assembly (104) varies, in use, the hydraulic pressure associated with the hydraulic-accumulator assembly (200).

Other aspects and features of the non-limiting embodiments will now become apparent to those skilled in the art upon review of the following detailed description of the non-limiting embodiments with the accompanying drawings.

### DETAILED DESCRIPTION OF THE DRAWINGS

The non-limiting embodiments will be more fully appreciated by reference to the following detailed description of the non-limiting embodiments when taken in conjunction with the accompanying drawings, in which:

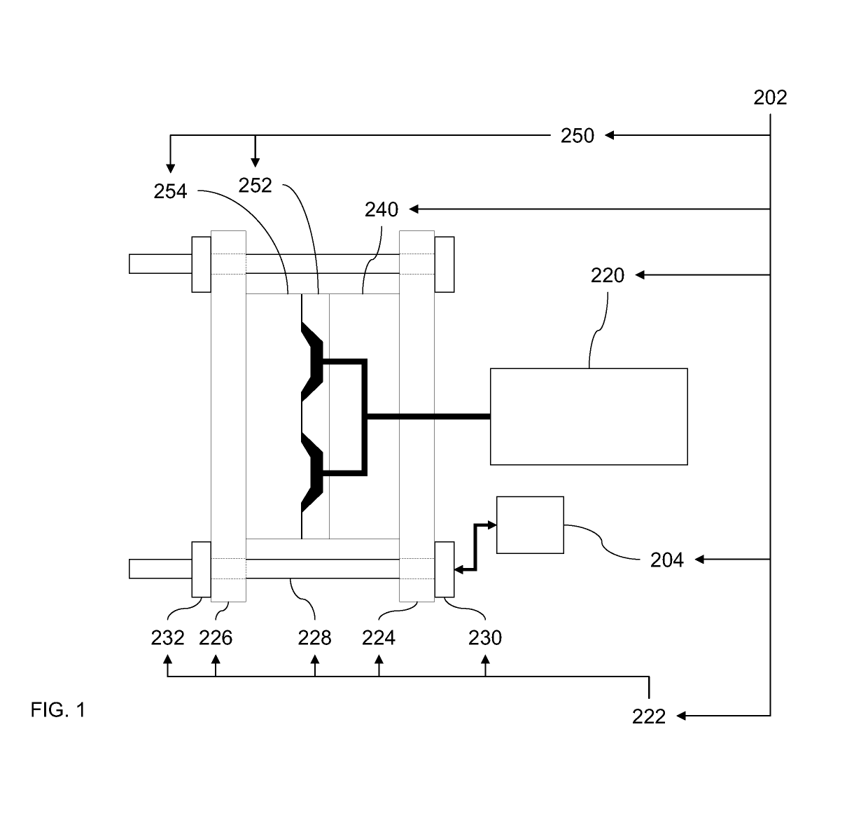

FIG. 1 depicts a schematic representation of a molding system (202); and

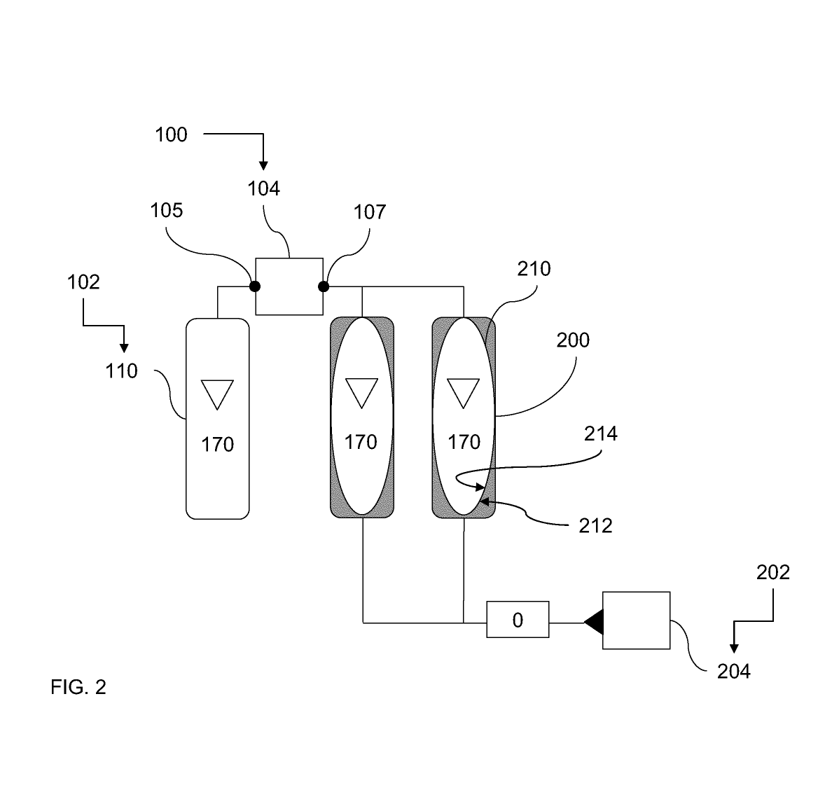

FIGS. 2, 3, 4, 5, 6, 7, 8A, 8B depict schematic representations of an apparatus (100) to be used with the molding system (202) of FIG. 1.

The drawings are not necessarily to scale and may be illustrated by phantom lines, diagrammatic representations and fragmentary views. In certain instances, details not necessary for an understanding of the embodiments (and/or details that render other details difficult to perceive) may have been omitted.

### DETAILED DESCRIPTION OF THE NON-LIMITING EMBODIMENT(S)

FIG. 1 depicts the schematic representation of a molding system (202). FIGS. 2, 3, 4, 5, 6, 7, 8A, 8B depict the schematic representations of the apparatus (100) to be used with the molding system (202) of FIG. 1. It will be appreciated that the examples depicted in FIGS. may be combined in any suitable permutation and combination. The apparatus (100) may include components that are known to persons skilled in the art, and these known components will not be described here; these known components are described, at least in part, in the following reference books (for example): (i) “Injection Molding Handbook” authored by OSSWALD/TURNG/GRAMANN (ISBN: 3-446-21669-2), (ii) “Injection Molding Handbook” authored by ROSATO AND ROSATO (ISBN: 0-412-99381-3), (iii) “Injection Molding Systems” 3^{rd} Edition authored by JOHANNABER (ISBN 3-446-17733-7) and/or (iv) “Runner and Gating Design Handbook” authored by BEAUMONT (ISBN 1-446-22672-9). It will be appreciated that for the purposes of this document, the phrase “includes (but is not limited to)” is equivalent to the word “comprising.” The word “comprising” is a transitional phrase or word that links the preamble of a patent claim to the specific elements set forth in the claim that define what the invention itself actually is. The transitional phrase acts as a limitation on the claim, indicating whether a similar device, method, or composition infringes the patent if the accused device (etc) contains more or fewer elements than the claim in the patent. The word “comprising” is to be treated as an open transition, which is the broadest form of transition, as it does not limit the preamble to whatever elements are identified in the claim.

By way of example (and not limited to the description thereof), FIG. 1 depicts the schematic representation of the molding system (202). The molding system (202) may include (and is not limited to): (i) a melt-preparation assembly (220), which may be also called an extruder, (ii) a clamp assembly (222), (iii) a runner assembly (240), and (iv) a mold assembly (250). It will be appreciated that the melt-preparation assembly (220), the clamp assembly (222), the runner assembly (240), and the mold assembly (250) may be provided by one vendor or may be provided by several vendors. By way of example, the clamp assembly (222) may include (and is not limited to): (i) a stationary platen (224), (ii) a movable platen (226) that may be movable relative to the stationary platen (224), (iii) a rod assembly (228) that may extend between the stationary platen (224) and the movable platen (226), (iv) a clamp unit (230) that may be mounted to the stationary platen (224) and may be configured to interface with the rod assembly (228), and (v) a lock assembly (232) that may be configured to selectively lock and unlock the movable platen (226) relative to the stationary platen (224), and may interact with the rod assembly (228) as well. The runner assembly (240) may be mounted to the stationary platen (224), and may face the movable platen (226). The mold assembly (250) may define a mold cavity used for forming molded articles. The mold assembly (250) may include (and is not limited to): (i) a stationary-mold portion (252) that may be mounted to the runner assembly (240) and face the movable platen (226), and (ii) a movable-mold portion (254) that is mounted to the movable platen (226) and faces the stationary-mold portion (252). The runner assembly (240) may be in fluid communication with the melt-preparation assembly (220) and with the stationary-mold portion (252). In operation, the movable platen (226) may be moved toward the stationary platen (224) so as to abut the movable-mold portion (254) against the stationary-mold portion (252) so as to form the mold cavity. The clamp assembly (222) applies a clamping force to the mold assembly (250), and then the melt-preparation assembly (220) prepares a flowable molding material that may be injected into the runner assembly (240), and the runner assembly (240) distributes the flowable molding material to the mold cavity of the mold assembly (250), so that the molded article may be formed. Once the article is formed, the movable platen (226) may be moved away from the stationary platen (224) so that the article may be removed from the mold assembly (250). In addition, the molding system (202) may include (and is not limited to) a hydraulic circuit (204). The hydraulic circuit (204) may be used, for example (and not limited to) providing a hydraulic fluid to the clamp unit (230) and other assemblies of the molding system (202), such as an injection unit or extruder if so required.

By way of example (and not limited to the description thereof), FIG. 2 depicts the schematic representation of the apparatus (100). The apparatus (100) may include (and is not limited to): a pressure-control assembly (104). The pressure-control assembly (104) may include or may have (and is not limited to): (i) a first interface unit (105), and (ii) a second interface unit (107). The first interface unit (105) may be configured to interface, in use, with a fluid-bottle assembly (102). The second interface unit (107) may be configured to interface, in use, with a hydraulic-accumulator assembly (200). The hydraulic-accumulator assembly (200) may be associated with the molding system (202) (although not depicted in FIG. 1 merely for ease of describing the example of FIG. 1). The hydraulic-accumulator assembly (200) may be configured to accumulate, under a hydraulic pressure, a hydraulic fluid. The hydraulic fluid may be associated with the hydraulic circuit (204), which is also depicted in FIG. 1. The pressure-control assembly (104) may be configured to communicate, in use, a fluid pressure between the fluid-bottle assembly (102) and with the hydraulic-accumulator assembly (200). In addition, the pressure-control assembly (104) may also be configured to controllably adjust, in use, the fluid pressure between the fluid-bottle assembly (102) and the hydraulic-accumulator assembly (200). The fluid pressure that is adjusted by the pressure-control assembly (104) varies (or changes), in use, the hydraulic pressure associated with the hydraulic-accumulator assembly (200). It will be appreciated that the molding system (202) may have or may include the apparatus (100) for the case where the molding system (202) is built by a vendor at the vendor's place of business (or manufacture). And it will be even more appreciated that the apparatus (100) may be retrofitted to the molding system (202) for the case where the molding system (202) exists at an end user's place of business (where molded article may be produced by the molding system (202). It may also be appreciated that the apparatus (100) may prepared or may be manufactured so that the apparatus (100) may include (and is not limited to): (i) the fluid-bottle assembly (102), and (ii) the pressure-control assembly (104). Alternatively, the fluid-bottle assembly (102) may be supplied by one vendor while the pressure-control assembly (104) may be supplied by another vendor altogether. For the case where the molding system (202) is manufactured by one single vendor that acts as a system integrator, to it will be appreciated that the molding system (202) may include (and is not limited to): (i) the hydraulic circuit (204), (ii) the hydraulic-accumulator assembly (200), (iii) the fluid-bottle assembly (102), and (iv) the apparatus (100). It will be appreciated that the other assemblies and or components identified by way of the description to FIG. 1 may also be included in the molding system (202) as well for the case where the molding system (202) is manufactured by one single vendor that acts as a system integrator. By way of example (and not limited to the following description), the hydraulic-accumulator assembly (200) may include (and is not limited to) a gas-bladder assembly (210) that may have an outer surface (212), and may also have an inner surface (214). The gas-bladder assembly (210) may also be called a gas-piston assembly (for example). The outer surface (212) may be interactive with the hydraulic fluid of the hydraulic circuit (204) and/or a piston accumulator or a diaphragm accumulator.

By way of example (and not limited to the following description), the fluid-bottle assembly (102) may include (and is not limited to) a gas-bottle assembly (110). The gas-bottle assembly (110) may be configured to communicate a gas pressure with the inner surface (214) of the gas-bladder assembly (210) of the hydraulic-accumulator assembly (200). It will be appreciated that other options may be possible if a gas-bottle assembly (110) is not used. It will be appreciated that the gas-bottle assembly (110) may include one or more multiple units or multiple gas bottles (for example). A single unit is depicted to provide a convenient example of the gas-bottle assembly (110). By way of example, the hydraulic-accumulator assembly (200) is depicted as having two accumulator units. It will be appreciated that the hydraulic-accumulator assembly (200) may include one, two, or any number of accumulator units. FIG. 2 depicts the hydraulic-accumulator assembly (200) has having two accumulator units by way of example.

Referring now to FIG. 2, the hydraulic-accumulator assembly (200) may hold a pre-charge pressure in the range of 1 to 170 bar (or higher). The system pressure may be in the range of 1-220 bar (or higher). FIG. 2 depicts an idle state or a rest condition, in which the hydraulic pressure of the hydraulic circuit (204) is lower than the gas pressures in the gas-bottle assembly (110). Gas pressures in the gas-bottle assembly (110) and the gas-bladder assembly (210) are relatively equal. The pressure-control assembly (104) may or may not be active in the state of operation depicted in FIG. 2. For FIG. 2, the hydraulic circuit (204) is indicated as having a pressure of zero bar.

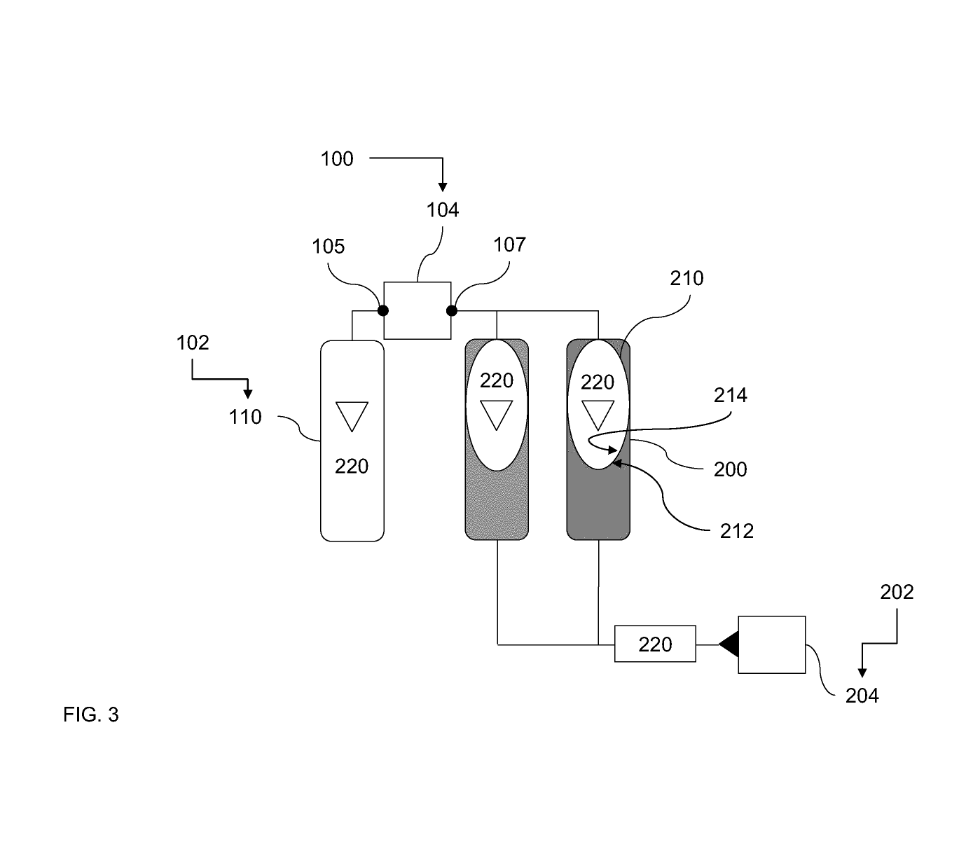

Referring now to FIG. 3, the hydraulic-accumulator assembly (200) is depicted as transitioning to an operating pressure. FIG. 3 depicts a state of pressure associated with the hydraulic circuit (204) being higher than the original at idle or rest gas pressure in the hydraulic-accumulator assembly (200). The hydraulic circuit pressure is typically generated (but not limited to) by a hydraulic pump (not depicted but known), The pressure of the hydraulic circuit (204) and the compressible fluid inside the hydraulic-accumulator assembly (200) will equalize or approximately equalize at the higher pressure level. The pressure-control assembly (104) allows some of the gas to be forced from the gas-bladder assembly (210) into the gas-bottle assembly (110). For FIG. 3, the hydraulic circuit (204) is indicated as having a pressure of 220 bar.

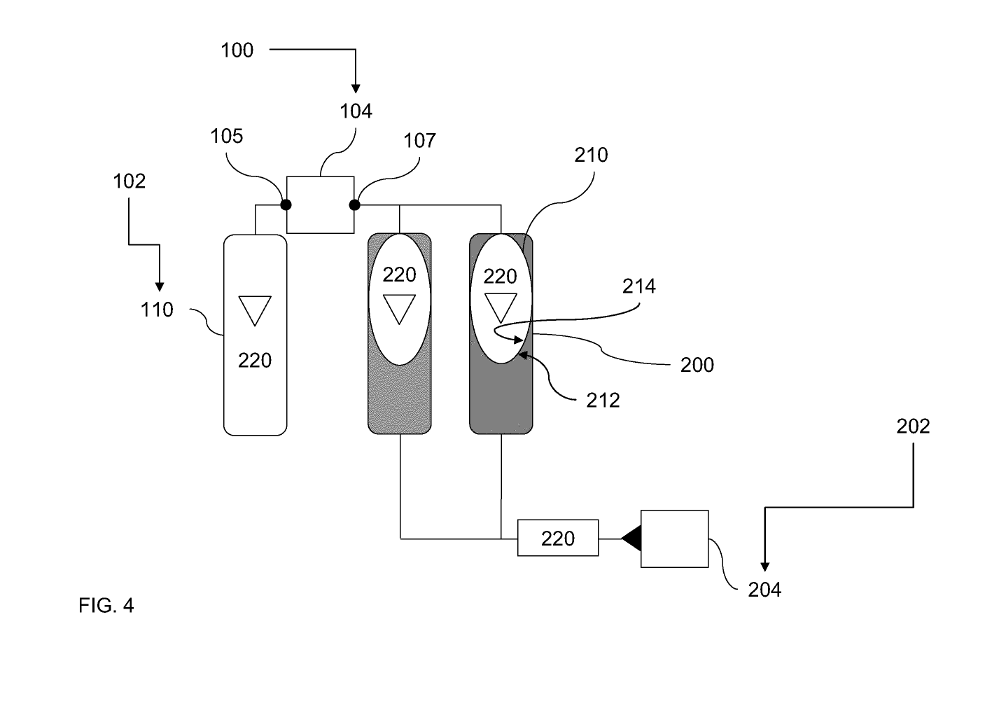

Referring now to FIG. 4, the fluid-bottle assembly (102) may receive additional pressure (such as storing nitrogen gas into the gas-bottle assembly (110) at an elevated pressure of 220 bar (for example). Then the pressure-control assembly (104) isolates the pressure between the fluid-bottle assembly (102) and the hydraulic-accumulator assembly (200). A portion of the gas that was in the gas-bladder assembly (210) has been transferred and isolated in the fluid-bottle assembly (102). For FIG. 4, the hydraulic circuit (204) is indicated as having a pressure of 220 bar.

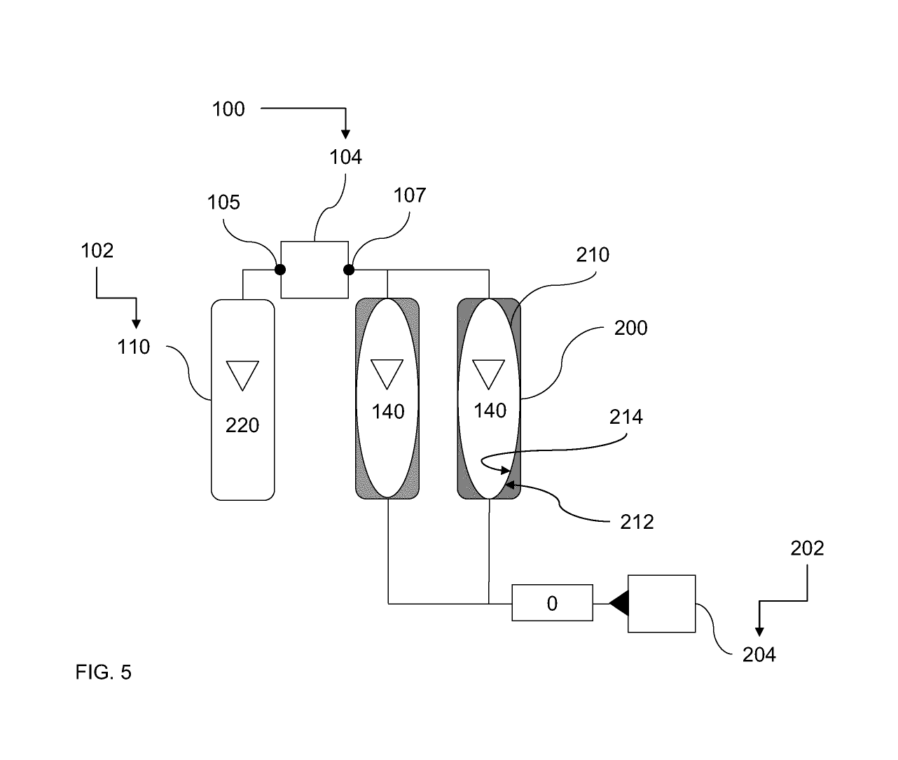

Referring now to FIG. 5, when the pressure from hydraulic circuit (204) is reduced or removed, the hydraulic-accumulator assembly (200) now has a lower resultant accumulator pressure, which may allow for optimum hydraulic pressure for an application (that is, for the manufacture of molded articles). Each application means that different types of molded articles are manufactured by the molding system (202). The pre-charge pressure of the hydraulic-accumulator assembly (200) may be in the range of 2 to 140 bar. The system pressure may be in the range of 2 to 180 bar. It will be appreciated that the actual pressure values are allowed to vary, and that the values depicted in the FIGS are the values for convenient illustration purposes only. For FIG. 5, the hydraulic circuit (204) is indicated as having a pressure of zero bar.

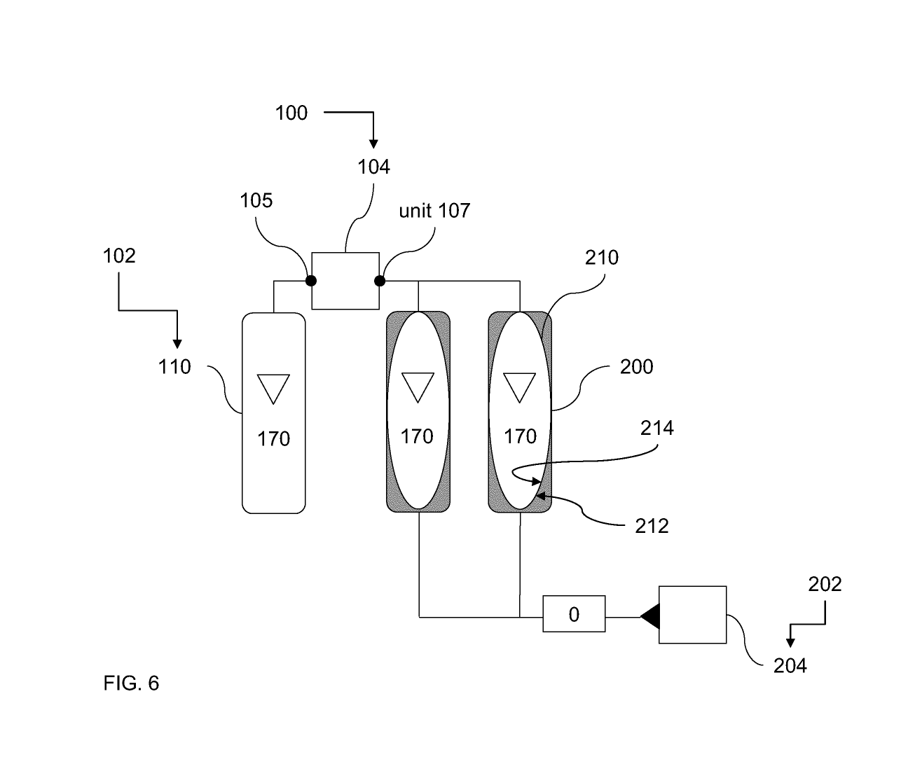

Referring now to FIG. 6, the pressure-control assembly (104) is configured to permit temporary fluid communication between the fluid-bottle assembly (102) and the hydraulic-accumulator assembly (200), and then closing or shutting off fluid communication between the fluid-bottle assembly (102) and the hydraulic-accumulator assembly (200). This arrangement then returns to the hydraulic-accumulator assembly (200) to the first pre-charge level (or an intermediate pressure). For FIG. 6, the hydraulic circuit (204) is indicated as having a pressure of 0 bar.

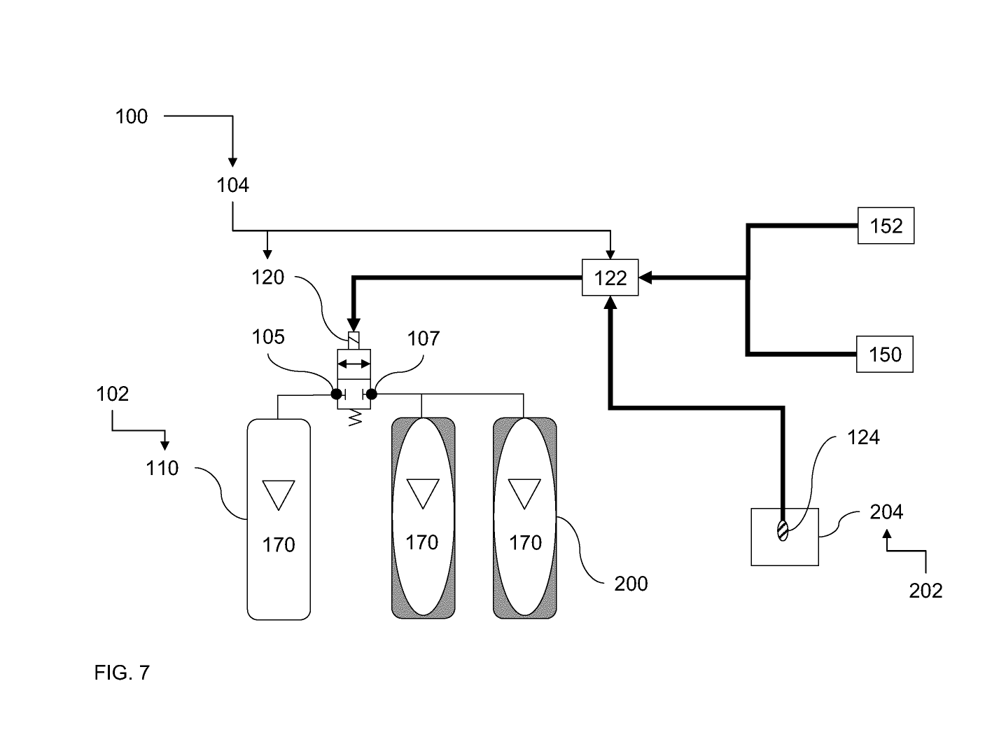

By way of example (and not limited by the description thereof), FIG. 7 depicts an example of the pressure-control assembly (104). The pressure-control assembly (104) may include (and is not limited to): a valve assembly (120) that may be configured to connect the gas-bottle assembly (110) with the gas-bladder assembly (210) of the hydraulic-accumulator assembly (200). It will be appreciated that the valve assembly (120) may also include a pump and compressor assembly as well (not depicted). The pressure-control assembly (104) may further include (and is not limited to): a controller unit (122) that may be configured to interface with and to control the valve assembly (120). The controller unit (122) and the valve assembly (120) may cooperate, in use, so as to vary the gas pressure between the gas-bladder assembly (210) and the gas-bottle assembly (110) so as to adjust the hydraulic pressure of the hydraulic-accumulator assembly (200). The controller unit (122) may be a digital controller or may be an analogue controller. The controller unit (122) may be a device that is configured to monitor and affect the operational conditions of a given dynamical system. The operational conditions are typically referred to as output variables of the system that may be affected by adjusting certain input variables. For example, the heating system of a house can be equipped with a thermostat (controller) for sensing air temperature (output variable) which can turn on or off a furnace or heater when the air temperature becomes too low or too high. In this example, the thermostat is the controller and directs the activities of the heater. The heater is the processor that warms the air inside the house to the desired temperature (set-point). The air temperature reading inside the house is the feedback. And finally, the house is the environment in which the heating system operates. The notion of controllers can be extended to systems that are more complex. The controller unit (122) may be a digital controller or an analogue controller. The controller unit (122) may input or read a current-pressure indication (150) that may indicate a current-hydraulic pressure of the hydraulic circuit (204). The current-pressure indication (150) may be provided, for example, by a sensor assembly (124) or other device. The sensor assembly (124) may be configured to sense and to provide the current-pressure indication (150) indicating a current hydraulic pressure of the hydraulic circuit (204). The controller unit (122) may input or read a desired-pressure indication (152) that may indicate a desired-hydraulic pressure of the hydraulic circuit (204) of the molding system (202). The desired-pressure indication (152) may be received, for example, from a human-machine interface (HMI, not depicted but known) or other device.

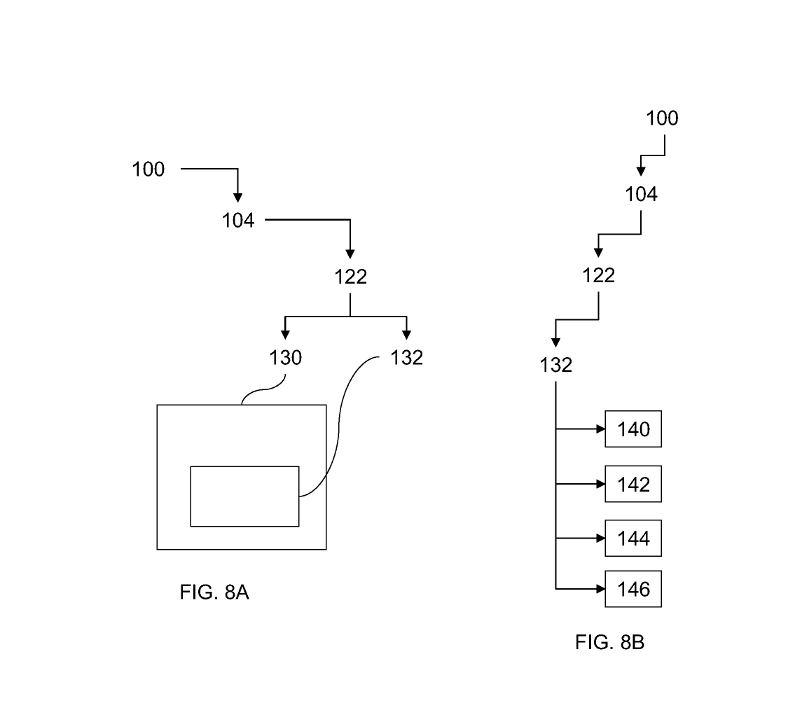

By way of example (and not limited by the description thereof), FIG. 8A depicts an example of the controller unit (122). The controller unit (122) may include (and is not limited to): a controller-unit readable medium (130) tangibly embodying executable programmed instructions (132). The controller-unit readable medium (130) may be a Compact Disk (CD), random access memory, etc. The controller unit (122) may be configured to: (i) read the executable programmed instructions (132) from the controller-unit readable medium (130). (ii) execute the executable programmed instructions (132). The executable programmed instructions (132) may be configured to instruct, in use, the controller unit (122) to control operations of the valve assembly (120).

By way of example (and not limited by the description thereof), FIG. 8B depicts example of the executable programmed instructions (132). The executable programmed instructions (132) may be further configured to instruct the controller unit (122) to execute a reading operation (140). The reading operation (140) may include (and is not limited to) reading the current-pressure indication (150) (depicted in FIG. 7) that may indicate the current-hydraulic pressure of the hydraulic circuit (204). The current-pressure indication (150) may be provided by the sensor assembly (124). The reading operation (140) may further include (and is not limited to) reading the desired-pressure indication (152) that may indicate the desired-hydraulic pressure of the hydraulic circuit (204) (as depicted in FIG. 7) of the molding system (202) (as depicted in FIG. 1). The executable programmed instructions (132) may be further configured to instruct the controller unit (122) to execute a computing operation (142). The computing operation (142) may include (and is not limited to) computing a difference between the current-pressure indication (150) and the desired-pressure indication (152). The executable programmed instructions (132) may be further configured to instruct the controller unit (122) to execute a writing operation (144). The writing operation (144) may include (and is not limited to) writing a valve-control signal. The valve-control signal may be configured to control operation of the valve assembly (120). In response receiving the valve-control signal, the valve assembly (120) may adjust the gas pressure between the gas-bladder assembly (210) and the gas-bottle assembly (110), based on the difference between the current-pressure indication (150) and the desired-pressure indication (152). The gas pressure that is adjusted, in use, may improve energy to efficiency associated with usage of the hydraulic pressure of the hydraulic-accumulator assembly (200). The executable programmed instructions (132) may be further configured to instruct the controller unit (122) to execute an adjustment operation (146). The adjustment operation (146) may include (and is not limited to) adjusting, in use, the fluid pressure between the gas-bladder assembly (210) and the gas-bottle assembly (110) so as to improve usable hydraulic volume output from the hydraulic-accumulator assembly (200) at a given hydraulic pressure.

It will be appreciated that the assemblies and modules described above may be connected with each other as may be required to perform desired functions and tasks that are within the scope of persons of skill in the art to make such combinations and permutations without having to describe each and every one of them in explicit terms. There is no particular assembly, components, or software code that is superior to any of the equivalents available to the art. There is no particular mode of practicing the inventions and/or examples of the invention that is superior to others, so long as the functions may be performed. It is believed that all the crucial aspects of the invention have been provided in this document. It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) description provided outside of this document (that is, outside of the instant application as filed, as prosecuted, and/or as granted). It is understood, for the purposes of this document, the phrase “includes (and is not limited to)” is equivalent to the word “comprising.” It is noted that the foregoing has outlined the non-limiting embodiments (examples). The description is made for particular non-limiting embodiments (examples). It is understood that the non-limiting embodiments are merely illustrative as examples.

1. An apparatus, comprising:
a pressure-control assembly having:
a first interface unit being configured to interface, in use, with a fluid-bottle assembly, the fluid-bottle being configured to store, in use, a fluid at an elevated fluid pressure; and
a second interface unit configured to interface, in use, with a hydraulic-accumulator assembly, the hydraulic-accumulator assembly being associated with a molding system, the hydraulic-accumulator assembly being configured to accumulate, under an hydraulic pressure, an hydraulic fluid, the hydraulic fluid being associated with an hydraulic circuit;
the pressure-control assembly being configured to:
communicate, in use, a fluid pressure between the fluid-bottle assembly and with the hydraulic-accumulator assembly; and
controllably adjust, in use, the fluid pressure between the fluid-bottle assembly and the hydraulic-accumulator assembly, the fluid pressure that is adjusted by the pressure-control assembly varies, in use, the hydraulic pressure associated with the hydraulic-accumulator assembly.

2. The apparatus of claim 1, wherein:
the hydraulic-accumulator assembly includes a gas-bladder assembly having an outer surface and also having an inner surface, the outer surface being interactive with the hydraulic fluid of the hydraulic circuit.

3. The apparatus of claim 2, wherein:
the fluid-bottle assembly includes a gas-bottle assembly, the gas-bottle assembly being configured to communicate a gas pressure with the inner surface of the gas-bladder assembly of the hydraulic-accumulator assembly.

4. The apparatus of claim 3, wherein:
the pressure-control assembly includes:
a valve assembly being configured to connect the gas-bottle assembly with the gas-bladder assembly of the hydraulic-accumulator assembly.

5. The apparatus of claim 4, wherein:
the pressure-control assembly further includes:
a controller unit being configured to interface with and to control the valve assembly, the controller unit and the valve assembly cooperating, in use, so as to vary the gas pressure between the gas-bladder assembly and the gas-bottle assembly so as to adjust the hydraulic pressure of the hydraulic-accumulator assembly.

6. The apparatus of claim 5, wherein:
the controller unit includes:
a controller-unit readable medium including executable programmed instructions; and
the controller unit being configured to:
read the executable programmed instructions from the controller-unit readable medium; and
execute the executable programmed instructions, the executable programmed instructions being configured to instruct, in use, the controller unit to control operations of the valve assembly.

7. The apparatus of claim 6, wherein:
the executable programmed instructions are further configured to instruct the controller unit to execute a reading operation, the reading operation including reading a current-pressure indication indicating a current-hydraulic pressure of the hydraulic circuit.

8. The apparatus of claim 7, wherein:
the reading operation further includes reading a desired-pressure indication indicating a desired-hydraulic pressure of the hydraulic circuit of the molding system.

9. The apparatus of claim 8, wherein:
the executable programmed instructions further configured to instruct the controller unit to execute a computing operation, the computing operation including computing a difference between the current-pressure indication and the desired-pressure indication.

10. The apparatus of claim 9, wherein:
the executable programmed instructions are further configured to instruct the controller unit to execute a writing operation, the writing operation including writing a valve-control signal, the valve-control signal being configured to control operation of the valve assembly.

11. The apparatus of claim 10, wherein:
in response receiving the valve-control signal, the valve assembly adjusts the gas pressure between the gas-bladder assembly and the gas-bottle assembly based on the difference between the current-pressure indication and the desired-pressure indication, the gas pressure that is adjusted, in use, improves energy efficiency associated with usage of the hydraulic pressure of the hydraulic-accumulator assembly.

12. The apparatus of claim 11, wherein:
the executable programmed instructions are further configured to instruct the controller unit to execute an adjustment operation, the adjustment operation including adjusting, in use, the fluid pressure between the gas-bladder assembly and the gas-bottle assembly so as to improve usable hydraulic volume output from the hydraulic-accumulator assembly at a given hydraulic pressure.

13. (canceled)

14. A molding system comprising:
a hydraulic circuit;
a hydraulic-accumulator assembly being configured to accumulate, under a hydraulic pressure, a hydraulic fluid, the hydraulic fluid being associated with the hydraulic circuit;
a fluid-bottle assembly, the fluid-bottle being configured to store, in use, a fluid at an elevated fluid pressure;
an apparatus including:
a pressure-control assembly having:
a first interface unit being configured to interface, in use, with the fluid-bottle assembly; and
a second interface unit being configured to interface, in use, with the hydraulic-accumulator assembly;
the pressure-control assembly being configured to:
communicate, in use, a fluid pressure between the fluid-bottle assembly and with the hydraulic-accumulator assembly; and
controllably adjust, in use, the fluid pressure between the fluid-bottle assembly and the hydraulic-accumulator assembly, the fluid pressure that is adjusted by the pressure-control assembly varies, in use, the hydraulic pressure associated with the hydraulic-accumulator assembly.
